(19) United States
(12) Patent Application Publication
(10) Pub. No.: US 2024/0326953 A1
(43) Pub. Date: Oct. 3, 2024

(54) SNOW VEHICLE FOR STAND-UP USE

(71) Applicant: 10696030 CANADA INC., Saguenay (CA)

(72) Inventors: Alain Aubut, Lac Kenogami (CA); Felix Gauthier, Chicoutimi (CA)

(21) Appl. No.: 18/739,801

(22) Filed: Jun. 11, 2024

Related U.S. Application Data
(63) Continuation-in-part of application No. 17/310,006, filed on Jul. 9, 2021.
(60) Provisional application No. 62/790,778, filed on Jan. 10, 2019.

(51) Int. Cl. B62M 27/02

(52) U.S. Cl. CPC B62M 27/02; B62M 2027/027

(57) ABSTRACT

A snow vehicle comprises a steering assembly, an endless track system, an engine system to power the endless track system and a platform adapted to be stood on by a rider or riders. The platform has a surface made of an anti-slip material, and the snow vehicle has a generally lower center of gravity thanks to its special structure, which facilitate safe operation for the rider.

### CROSS-REFERENCE TO RELATED APPLICATIONS

The present patent application claims the benefits of priority of U.S. Patent Application No. 62/790,778, entitled “Snow vehicle for stand-up use” and filed at the USPTO on Jan. 10, 2019, the content of which is incorporated herein by reference.

### FIELD OF THE INVENTION

The present invention generally relates to snow vehicles. More particularly, the present invention relates to a type of snow vehicle having a platform upon which the rider stands during the operation of the snow vehicle.

### BACKGROUND OF THE INVENTION

Snow vehicles are very popular in many countries, such as Canada, Japan, and USA. Generally, there are two kinds of recreational snow vehicles. One is a stand-up snow vehicle, and the other one is a seater snow vehicle with a seat provided for the rider. Snow vehicles are generally propelled by an endless track system and steered by one or more skis installed at the front thereof. Such snow vehicles also comprise a seat or a platform for the rider, and a steering assembly, thereby controlling the operation for the rider.

Several snow vehicles have been patented. For example, U.S. Pat. No. 6,234,263 to A&D Boivin Design discloses a single seater snowmobile type recreational vehicle. The snowmobile comprises a complicated steering system and the center of gravity thereof is relatively high so it is not easy for the driver to safely control the snowmobile. As the steering system and the vehicle frame have a complicated assembly connection means, its production and maintenance will not be economical.

Another example of a snow vehicle is shown in U.S. Pat. No. 7,475,751 to Bombardier Recreational Products Inc. which discloses a stand-up snow vehicle comprising a steering assembly for steering a ski, an endless track and an engine system to propel the vehicle. The snow vehicle also comprises a simple rear suspension assembly supporting the endless track system which limits the operation environment. The geometry does not allow good floatability and manoeuvrability in deep snow.

### SUMMARY OF THE INVENTION

The shortcomings of the prior art are generally mitigated by providing a snow vehicle for stand-up use which is safer and easier to build and operate and which has improved floatability and/or maneuverability.

In an aspect invention, the snow vehicle generally comprises a steering assembly, an endless track system, an engine system to power the endless track system and a platform adapted to be stood on by a rider.

Preferably, the platform is rectangular and has a surface made of an anti-slip material with channels allowing the removal of ice and snow more easily. A platform with such a surface may allow the driver to stay upright, even in sharp turns.

Preferably, the angle of inclination of the platform forces the user to stand closer to the engine compartment and thus position the center of gravity of the vehicle and user under the user. In one aspect, the angle of inclination of the platform is between 2 and 10 degrees from the horizontal with a preferred angle being between 5 and 7 degrees from the horizontal.

The narrow width of the platform and of the vehicle also requires the user to adopt a sporty driving position and allows him/her to access places normally inaccessible to a snowmobile.

In another aspect of invention, the stand-up snow vehicle also has an angle between the steering column assembly and the horizontal which increases the distance between the ski contact zone and the endless track contact zone to better absorb bumps and minimize the force transfer impact of deceleration and acceleration.

In another aspect of invention, the steering assembly comprises vehicle frames and

handlebars pivotable about a generally vertical axis which allow the vehicle to be steered. The vehicle frames generally comprise a substantially vertical frame and a central frame member. Under the vehicle frames and the central frame member, there is a triangular space to install an engine system. There is also provided a bracket element to enclose the mechanical power transmission means.

In another aspect of invention, inside the endless track system, a rear suspension assembly comprising a front suspension arm and a rear suspension arm is provided. A shock absorber is coupled to one end of the front suspension arm and the rear suspension arm which makes the operation of the snow vehicle much more stable.

In still another aspect, the stand-up snow vehicle comprises:
a steering assembly disposed at a first angle from the horizontal, the steering assembly comprising a ski having a first ground contact zone;
at least one endless track system comprising a sprocket wheel driving a flexible track having a second ground contacting zone;
an engine system driving the sprocket wheel; and
a platform to support the standing user, wherein the platform is inclined at a second angle from the horizontal.

In yet another embodiment, the stand-up snow vehicle comprises:
a steering assembly positioned at an angle of 63 degrees plus or minus 1 degree from the horizontal to optimize the absorption of bumps while minimizing the force transfer impact of deceleration and acceleration, the steering assembly comprising a ski having a first ground contact zone, the ski being rotatable by a user to change a direction and course of the vehicle;
at least one endless track system comprising a sprocket wheel driving a flexible track having a second ground contact zone;
an engine system;
a platform positioned at an angle of 6 degrees plus or minus 1 degree from the horizontal;
wherein the center of gravity is positioned close to the ground due to acute angles of the suspension arms relative to the forwardly mounted support mean and the low height of the center frame and the components encompassed within.

In another aspect, the stand-up snow vehicle has an engine system which is segmented into a top end and a bottom end, and the center of gravity is positioned within the bottom end of the engine system.

The stand-up snow vehicle may also have the entire bottom end of the engine situated within a predetermined track clearance area.

The stand-up snow vehicle of the invention may further comprise a reversed Continuously Variable Transmission (CVT) pulley system with the driving pulley located at the rear and the driven pulley positioned at the front, such that the taut strand of the transmission belt is oriented downward.

In another aspect, the first ground contact zone and the second ground contact zone of the vehicle have matching profiles.

As used herein, the word “substantially” has the meaning provided in the Meriam-Webster dictionary which is: “being largely but not wholly that which is specified” while the words “about” and “approximately” have the following meaning: “reasonably close to” or “within +/−10%”.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is a front perspective view of embodiment of a snow vehicle in accordance with the principles of the present invention;

FIG. 2 is a front elevational view of the snow vehicle of FIG. 1;

FIG. 3 is a rear elevational view of the snow vehicle of FIG. 1;

FIG. 4 is a right side elevational view of the snow vehicle of FIG. 1;

FIG. 5 is a left side elevational view of the snow vehicle of FIG. 1;

FIG. 6 is a top plan view of the snow vehicle of FIG. 1;

FIG. 7 is a right side elevational view of the snow vehicle with a geometry of the vehicle; and

FIG. 8 is a right side elevational view of the snow vehicle illustrating the platform angle and the steering assembly angle in a preferred embodiment of the invention.

FIG. 9 is a front perspective view of another embodiment of a snow vehicle in accordance with the principles of the present invention;

FIG. 10 is a rear elevational view of the snow vehicle of FIG. 9;

FIG. 11 is a front elevational view of the snow vehicle of FIG. 9;

FIG. 12 is a bottom view of the snow vehicle of FIG. 9;

FIG. 13 is a top view of the snow vehicle of FIG. 9;

FIG. 14 is a right side elevational view of the snow vehicle of FIG. 9;

FIG. 15 is a left side elevational view of the snow vehicle of FIG. 9;

FIG. 16 is a right side elevational view of the snow vehicle illustrating the geometry of the vehicle;

FIG. 17 is a left side elevation view of the engine of the snow vehicle of FIG. 9;

FIG. 18 is a right side elevation view of the engine of the snow vehicle of FIG. 9;

FIG. 19 is a partial right side elevation view of the engine of the snow vehicle of FIG. 9 as installed in the vehicle;

FIG. 20 is a partial front elevation view of the track and ski of the snow vehicle of FIG. 9.

### DETAILED DESCRIPTION OF THE PREFERRED EMBODIMENT

A novel snow vehicle for stand-up use will be described hereinafter. Although the invention is described in terms of specific illustrative embodiments, it is to be understood that the embodiments described herein are by way of example only and that the scope of the invention is not intended to be limited thereby.

A stand-up snow vehicle is provided. The snow vehicle generally comprises a steering assembly, an endless track system, an engine system to power the endless track system and a platform adapted to be stood on by a rider or riders. Additionally, safe operation of the invention may be improved with a platform made of anti-slip material and a low center of gravity of the same.

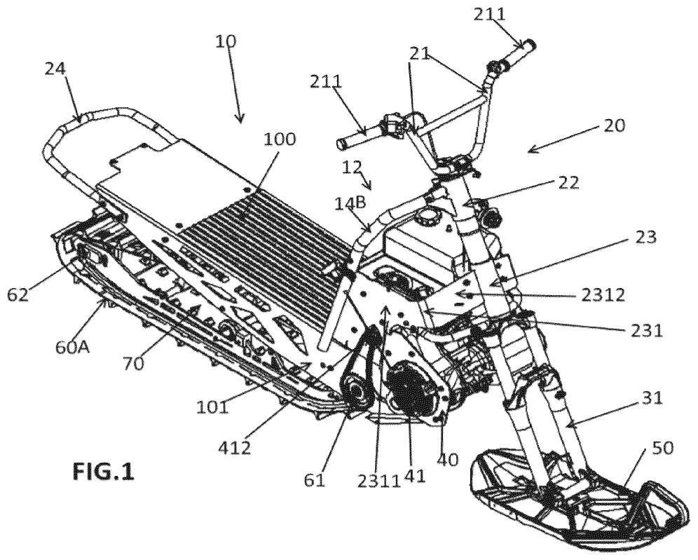

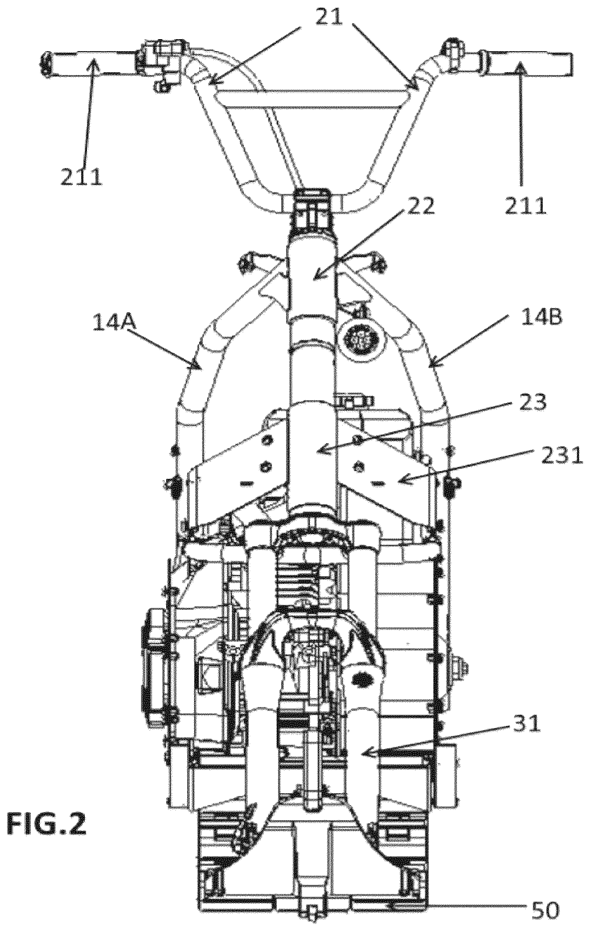

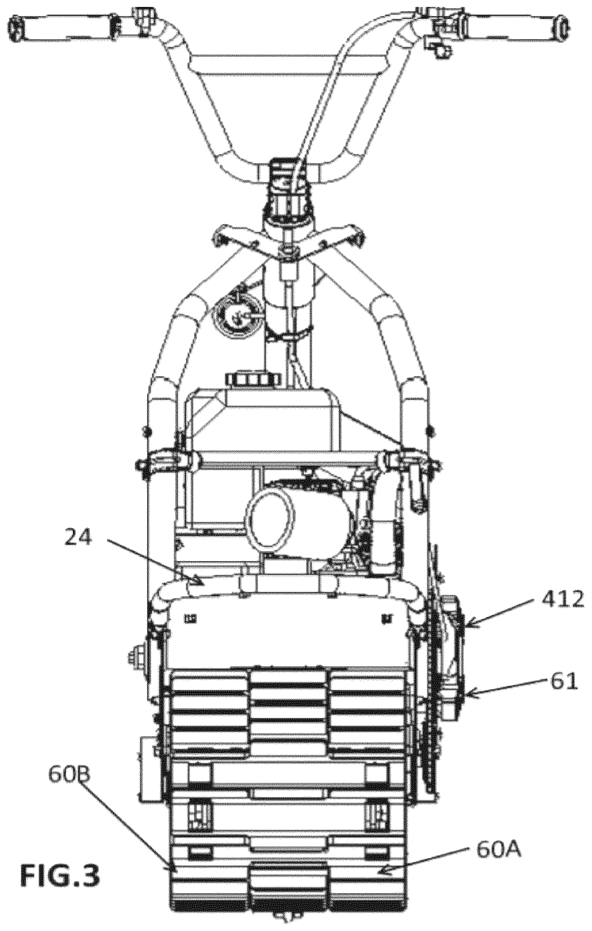

Now referring to FIGS. 1-3, an embodiment of a snow vehicle 10 is shown. The snow vehicle 10 generally comprises a steering assembly 20, an endless track system 60, an engine system 40 to power the endless track system 60 and a platform 100 adapted to be stood on by a rider or riders.

In some embodiments, the steering assembly 20 comprises a frame 12 and handlebars 21. As shown in FIG. 1, the handlebars 21 generally comprise a pair of handles 211 which are disposed on each side of the handlebars 21. The handlebars 21 may be in any shape known to the people skilled in the art. The frame 12 generally comprises a substantially vertical frame 14 and a central frame member 22. The substantially vertical frame 14 is fixed to a lower vehicle plate 101, which will be illustrated later. The vehicle's substantially vertical frame 14 generally extends upwardly and forwardly from the connection point with the lower vehicle plate 101. The central frame member 22, at the top end of which is connected to the handlebars 21 and to the substantially vertical frame 14, generally extends downwardly and forwardly. The distal or lower end of the central frame member 22 is connected to a ski connection frame member 31. Preferably, a front suspension element 23 is pivotally mounted to the lower end of the central frame member 22 to pivot when passing through the central frame member 22.

Understandably, the vehicle's substantially vertical frame 14 generally comprises a pair of frames 14A and 14B respectively disposed on the left side and the right side of the snow vehicle 10. The right frame 14A is fixed to the right lower vehicle plate 101. Likewise, the left frame 14B is fixed to the left lower vehicle plate 101. The two vehicle's substantially vertical frames 14A and 14B extend to the connection part with the handlebars 21. Under these two frames 14A and 14B and the central frame member 22, the engine system 41 will be installed. Details will be illustrated later.

In some embodiments, the ski connection frame member 31 having one or more parallel axes generally extends forwardly and downwardly to a ski 50. In an illustrated embodiment shown in FIG. 1, the ski connection frame member 31 comprises two parallel axes fixed to the ski 50. Any kind of structure of the ski known to the people skilled in the art may be used and any fastening method known to the people skilled in the art to fasten the frame to the ski may be used.

All power train components, the front upper part of the frame (steering reinforcement tube) and the rear part of the frame (tunnel), may be linked by aluminium die casted and extruded parts.

The front upper part of the frame and rear part of the frame may be mechanically assembled on a center frame part made from die casted aluminium to ensure a precise and robust assembly.

The power train comprises a horizontal engine equipped with a continuously variable transmission (CVT). A belt 413 between the driving pulley and the driven pulley transfers the power of the engine to a drive shaft. The drive shaft operates a chain sprocket 412. A chain transfers the power of the engine to the track sprocket axle 61. All these components may be mounted directly in the center frame part and made from die casting aluminium to ensure a precise aligned fit and, at the same time, increase the belt 413 durability.

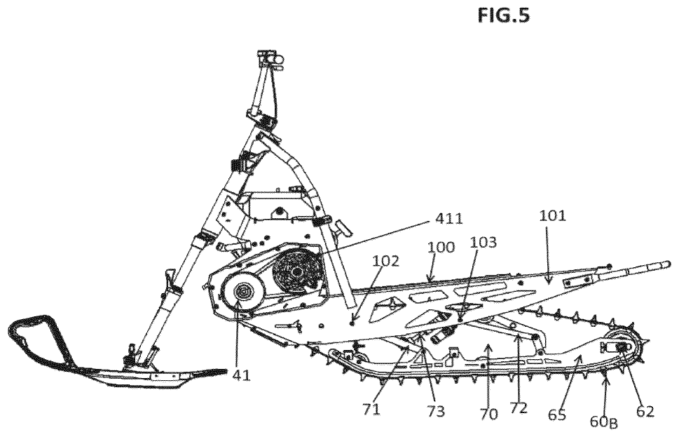

Now referring to FIGS. 1, 4 and 5, an endless track system is shown. The endless track system 60A-B is disposed at the rear of the steering assembly 20. Generally, there are two parallel endless track systems 60A and 60B driven by two parallel sprocket wheels 61 and two parallel idler wheels 62. A rear suspension assembly 70 is coupled to the inner side of each endless track system 60A and 60B. Preferably, a rear suspension assembly 70 comprises a front suspension arm 71 and a rear suspension arm 72. The rear suspension assembly 70 further comprises support means 65 having front and rear portions fixed to the wheels of the endless track system 60A-B. The support means 65 has a plurality of apertures therein for receiving the front suspension arm 71 and the rear suspension arm 72 respectively. A shock absorber 73 is coupled to the other end of the front suspension arm 71 and the rear suspension arm 72. Only one shock absorber may be used in the rear suspension assembly to reduce the cost of the snow vehicle.

Understandably, the two parallel endless track systems 60A and 60B with the rear suspension assembly 70 are identical to each other. They are symmetrical to the centre of the snow mobile 10. To facilitate the description, we will distinguish these two endless track systems as the left endless track system, and the right endless track system.

In some preferable embodiments, the front suspension arm 71 and the rear suspension arm 72 are inclined at an acute angle with respect to the forwardly mounted support means 65, which is useful to reduce the height of the snow vehicle. With this structure of chassis, the centre of gravity of the snow vehicle is relatively low and the snow vehicle will be more stable compared to prior art stand-up snow vehicles.

Still referring to FIGS. 1, 4 and 5, an engine system 40 to power the endless track system is illustrated. The engine system 40 is installed between the endless track systems 60A-B and the steering assembly 20. The engine system 40 generally comprises an engine 41 which generates power to actuate the operation of the endless track system through a mechanical power transmission means 61, 411, 412. Any kind of mechanical power transmission means known to the people skilled in the art may be used, such as V-belts, chains and so on. As illustrated in FIGS. 1, 4 and 5, the mechanical power transmission means is a belt transmission system. When the engine, connected to driving pulley 41, starts to work, it actuates a belt 413 which transmits power to a driven pulley 411 and to a second sprocket wheel 412 connected to the same shaft. It further actuates the operation of the sprocket wheel 61 via a chain, which then translates to the endless track systems 60A-B. A fairing (not shown in the figures) may be preferably installed to enclose the engine system 40 as to prevent injuries and to protect the engine system 40 from contamination by snow or mud.

As discussed above, the engine system 40 is installed between the endless track systems 60A-B and the steering assembly 20. More so, under the frame 12 and the central frame member 22, there is a triangular space in which the engine system 40 is installed in order to save space and further improve the overall structure of the snow mobile and result in a lower center of gravity. As the centre of gravity of the snow vehicle is relatively low, it will be easier for a rider to operate the vehicle with the advantage of better floatability- and maneuverability.

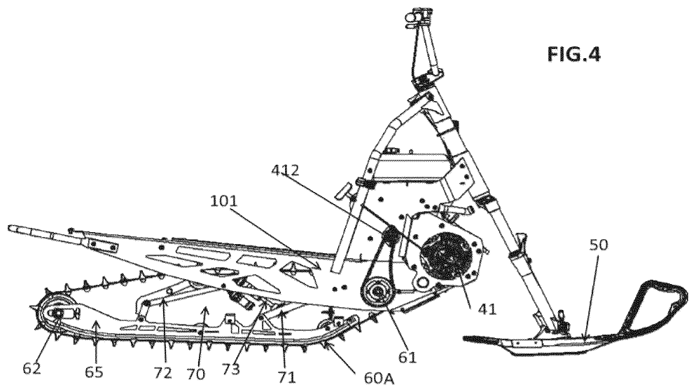

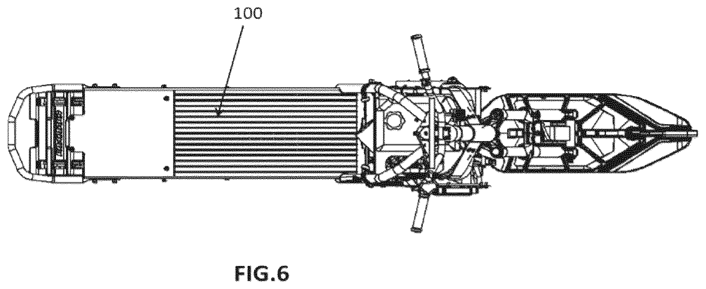

Now referring to FIGS. 4-6, in some embodiments, an anti-slide platform 100 with a pair of lower side plates 101 is mounted between the steering assembly 20 and the endless track systems 60A-B. There are a plurality of apertures 102, 103 in the plates 101, some of which are fastened to the rear suspension element. Any fastening method known to the people skilled in the art could be used, such as nuts and bolts, or welding. At least one part of the surface of the anti-slide platform 100 is made from a material having a high roughness, which will allow the driver to stay upright in turns. Preferably, the length of the platform 100 is identical to the length of the endless track systems 60A-B. At the rearmost end of the platform, a U-shaped frame 24 is optionally provided, which is fastened adjacent the rear end of the lower vehicle plate 101. Any fastening method known to the people skilled in the art could be used, such as nuts and bolts, or welding.

Preferably, there is provided a bracket element 231 to enclose the mechanical power transmission means and to support a fairing (not shown). The bracket element 231 generally comprises two side vertical plates 2311 and two front substantially vertical forwardly plates 2312 which are fixed to the front suspension element 23. Any fastening method known to the people skilled in the art could be used, such as nuts and bolts, or welding. As discussed above, the bracket element 231 may pivot about the central frame member 22.

In an alternative embodiment, the steering assembly 20, the engine system 40 and the bracket element 231 may be in the form of a module separate from the vehicle endless track system and the ski connection system 31 as a whole, which will facilitate the assembly. Another merit for the module is that it will reduce the torsion during operation.

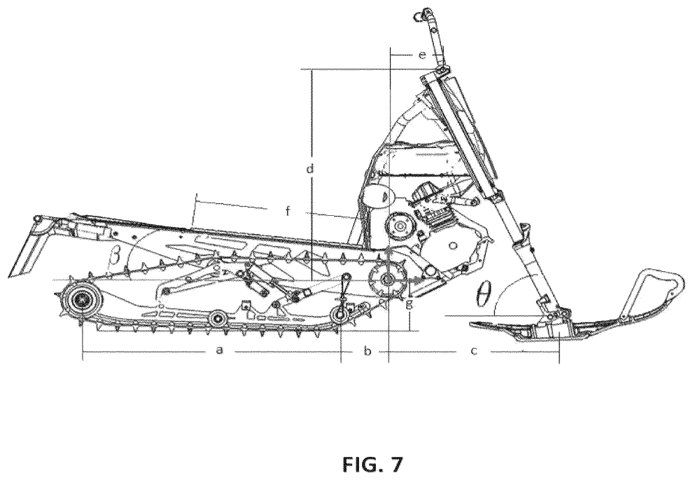

As shown in FIG. 7, a coordinate system is centered on the track sprocket axle 61.

The coordinate system is centered at a height of (g) from the ground. In the example shown, (g) corresponds to an embodiment of about 220 mm. The measurements and angles shown in FIG. 7 correspond to an illustrative example and should not be considered as limitations to the inventive features of the invention. All illustrative measurements have an uncertainty of +15 mm and +1 degree.

In the example shown in FIG. 7, reference (a) corresponds to an approximate 900 mm rear track contact patch that is in contact with the ground starting at about 220 mm rearwardly from the sprocket axle 61 as represented by reference (b). The center contact point of the ski is located at about 600 mm in front of the center of the coordinate system, as referenced by (c). The ski is controlled by the driver with a steering assembly 20 (handlebars 21, stem, steering axle and fork) at an angle θ from horizontal axis, which in this example corresponds to about 63 degrees. The handlebars 21 are directly mounted in a stem that, in this example, is located at around 790 mm above and 190 mm in front of the center of the coordinate system as illustrated by references (d) and (e) respectively. In use, the driver stands up on the platform 100 at a location that extends approximately 1100 mm rearwardly of the center of the coordinate system as illustrated by reference (f).

Preferably, the platform 100 is slightly angled from the horizontal at an angle β. In the example shown in FIG. 7 the angle ß corresponds to approximately 6 degrees.

The width of the platform is preferably narrow; for example it may have a width of between 300 and 355 mm. The narrow width of the platform requires the user to adopt a sporty driving position and allows the vehicle to access places normally inaccessible to a snowmobile.

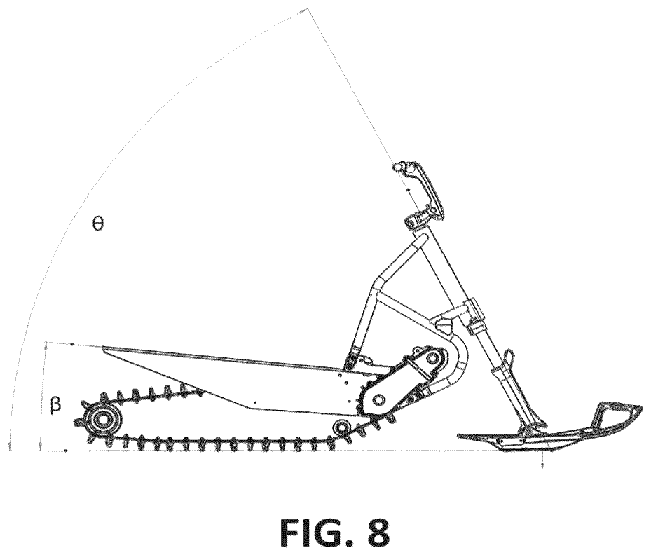

FIG. 8 shows a preferred embodiment wherein both the steering assembly 20 and the platform 100 are set with specific angles. In this embodiment, the steering assembly 20 is at an angle Θ of about 63.5 degrees from the horizontal while the platform 100 is at an angle β of about 5.5 degrees from the horizontal. Those two angles may provide the most ergonomic position for a user of the invention, and provide thereof more enjoyment and better control of the same. Nonetheless, the same two angles may be part of pre-determined ranges in order to offer more production or user specific accommodations. As such, the steering assembly 20 may preferably have an angle of 62 to 67 degrees while the platform 100 may preferably have an angle of 4 to 8 degrees. Setting both angles at values over or under the abovementioned range may be detrimental to the comfort of a user and, as such, the performance of the invention. For example, setting a platform 100 at an angle over 8 degrees from the horizontal may make the user loose his balance in front of him/her. In the opposite, setting it under 4 degrees may induce contact between the platform 100 and components under it when the suspension is compressed which is to be avoided.

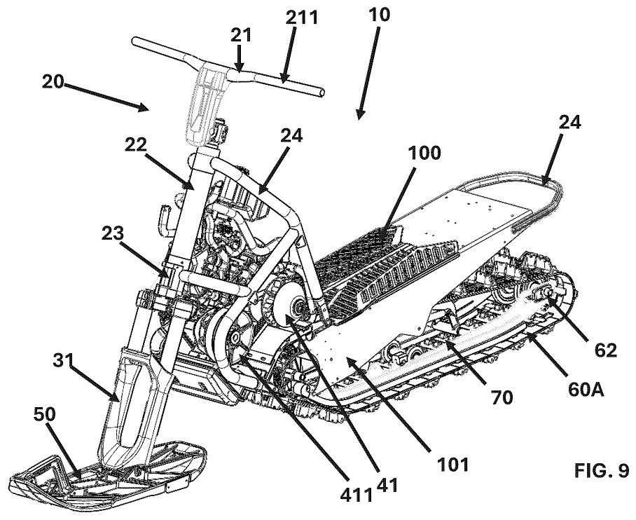

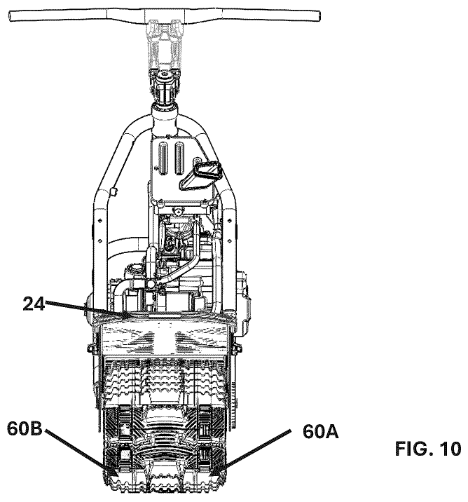

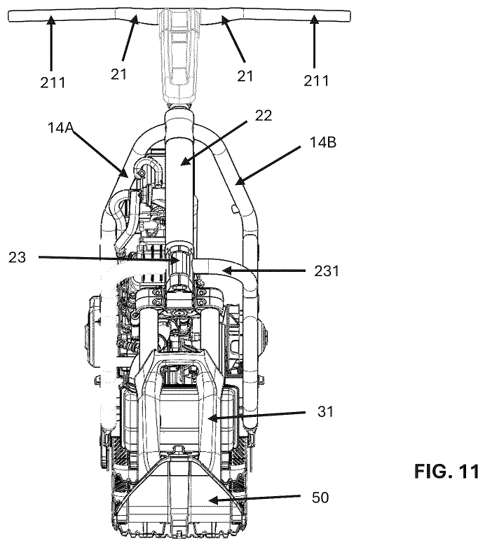

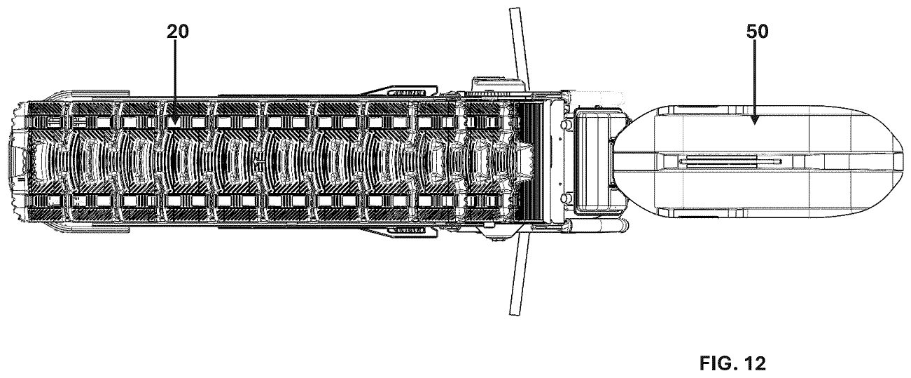

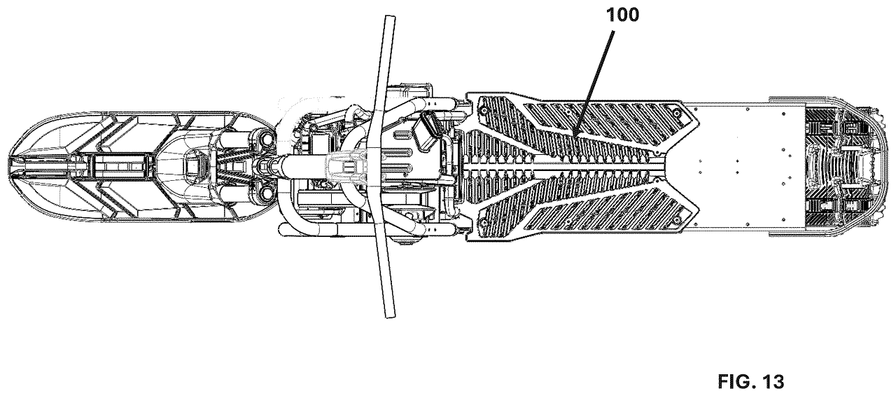

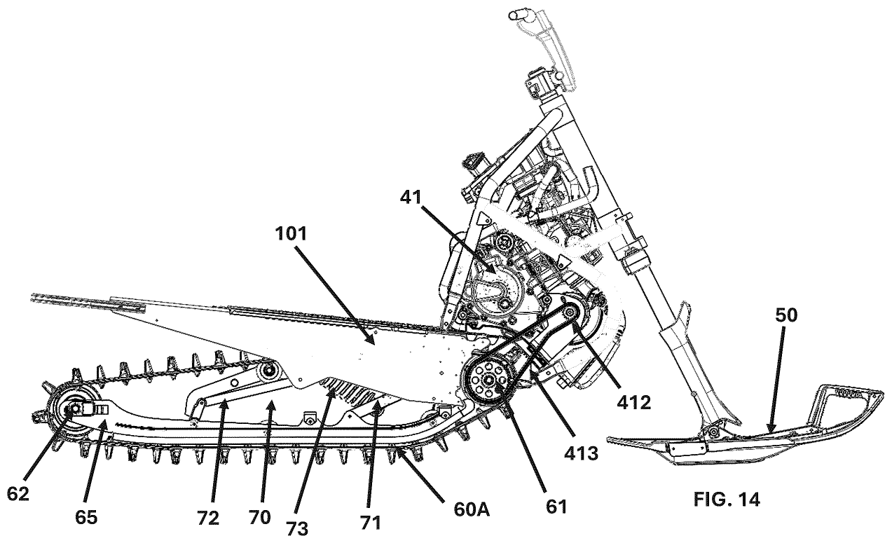

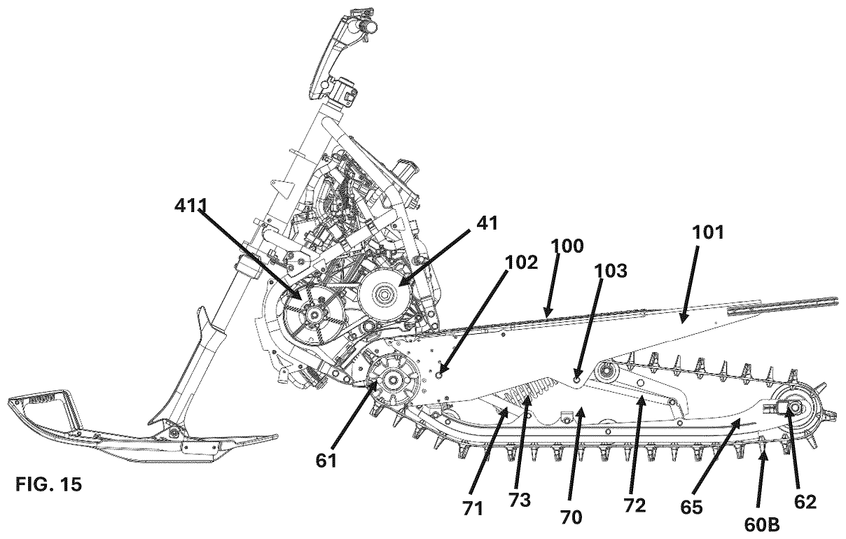

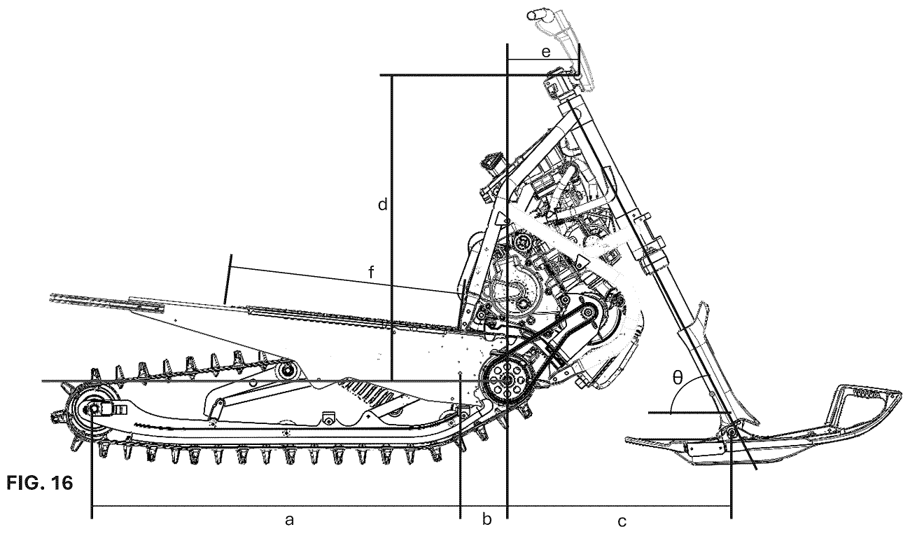

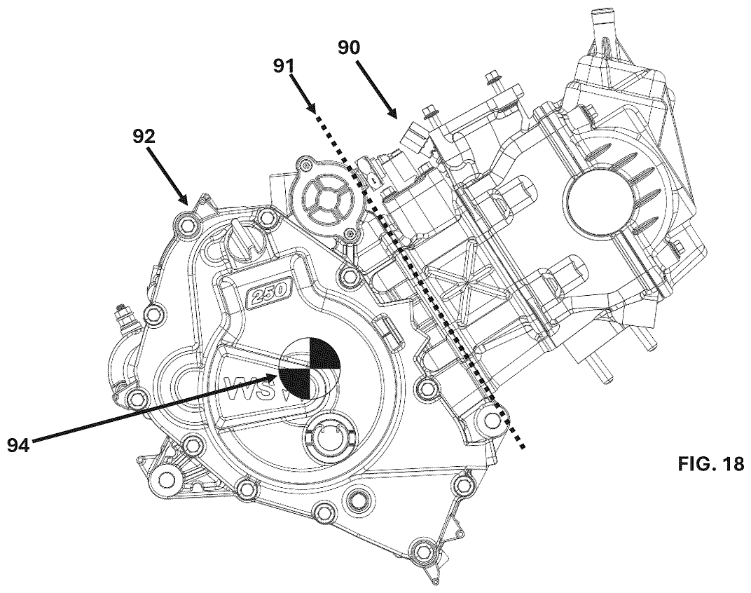

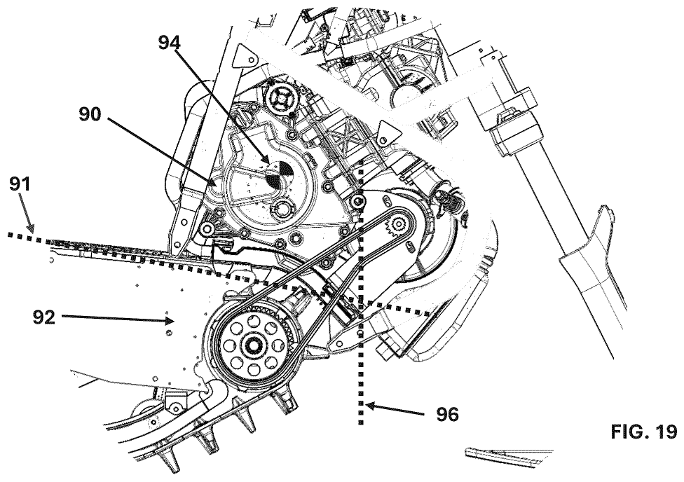

In another embodiment of the invention depicted in FIGS. 9-20, significant enhancements focus on the geometrical configuration and mechanical integration within the vehicle, tailored to maximize control and efficiency in challenging terrains. This iteration of the design meticulously maintains the general dimensions of the vehicle as in previous embodiments but introduces pivotal adjustments to the engine 40's placement and transmission system.

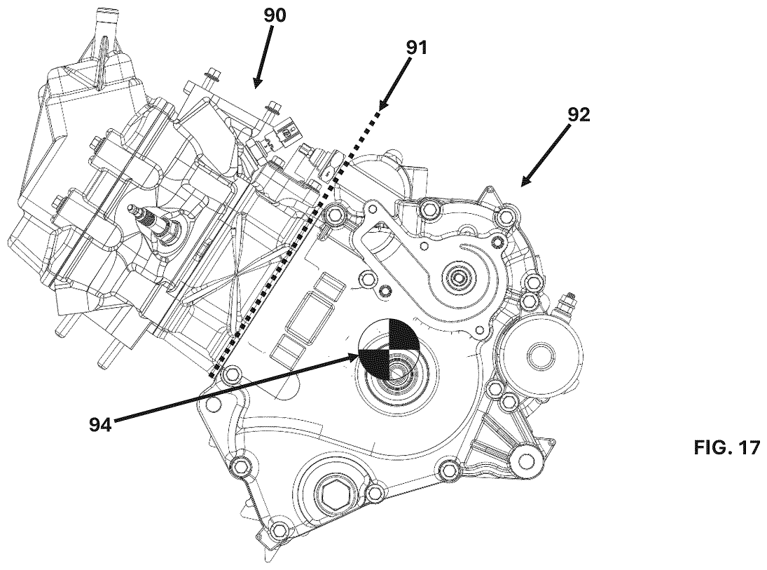

Referring specifically to FIGS. 17-19 the engine 40 may be divided into a top end 90 and a bottom end 92, separated as illustrated by a dotted line 91. Fundamentally the engine 40 has been repositioned to align its center of gravity 94 centrally within the bottom end 90, specifically situated inside the track clearance limit 96. This strategic positioning not only optimizes the vehicle's balance by aligning its center of mass closer to the user's but also ensures that the entire bottom end 90 of the engine 40 stays within the designated track clearance area. This configuration mitigates the risk of terrain interference, thus enhancing the vehicle's operational stability.

In terms of the transmission integration, a novel inversion of the Continuously Variable Transmission (CVT) pulley system marks a significant departure from previous vehicles. The driving pulley 41 is now located at the rear, while the driven pulley 411 is placed at the front of the assembly. This arrangement causes the taut strand of the transmission belt 413 to be oriented downward, which contributes to a lower center of gravity 94 and reduces the potential for slippage or misalignment under dynamic conditions.

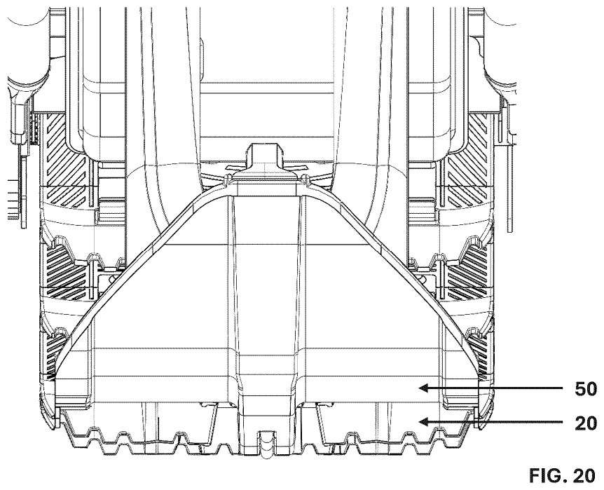

Additionally, referring now to FIG. 20 the vehicle benefits from a harmonized design between the track system 20 and ski 50, with matching profiles that facilitate a seamless transition and stable contact points during maneuvers such as slaloms. This synchronization ensures that the central, right, and left support points of the track system 60A-B and ski are at the same level, significantly smoothing the transition curves and improving the user's control during sharp turns or rapid directional changes. While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1) A stand-up snow vehicle comprising:
a steering assembly disposed at a first angle from the horizontal, the steering assembly comprising a ski having a first ground contact zone;
at least one endless track system comprising a sprocket wheel driving a flexible track having a second ground contacting zone;
an engine system driving the sprocket wheel;
a platform to support the standing user, wherein the platform is inclined at a second angle from the horizontal.

2) A stand-up snow vehicle as claimed in claim 1, wherein the total width of the second ground contact zone is substantially equal to the width of the first ground contact zone.

3) A stand-up snow vehicle as claimed in claim 1, wherein the engine system is segmented into a top end and a bottom end, and the center of gravity is positioned within the bottom end.

4) A stand-up snow vehicle as claimed in claim 3, wherein the entire bottom end of the engine is situated within a predetermined track clearance area.

5) A stand-up snow vehicle as claimed in claim 1, further comprising a reversed Continuously Variable Transmission (CVT) pulley system with the driving pulley located at the rear and the driven pulley positioned at the front, such that the taut strand of the transmission belt is oriented downward.

6) A stand-up snow vehicle as claimed in claim 2, wherein the first ground contact zone and the second ground contact zone have matching profiles.

7) A stand-up snow vehicle as claimed in claim 1, wherein the first angle is between 60 and 68 degrees from the horizontal.

8) A stand-up snow vehicle as claimed in claim 2, wherein the first angle is between 62 and 67 degrees from the horizontal.

9) A stand-up snow vehicle as claimed in claim 3, wherein the first angle is 63 degrees plus or minus 1 degree from the horizontal.

10) A stand-up snow vehicle as claimed in claim 1, wherein the second angle is between 4 and 10 degrees from the horizontal.

11) A stand-up snow vehicle as claimed in claim 5, wherein the second angle is between 5 and 8 degrees from the horizontal.

12) A stand-up snow vehicle as claimed in claim 6, wherein the second angle is 6 degrees plus or minus 1 degree from the horizontal.

13) A stand-up snow vehicle as claimed in claim 1, wherein the second ground contacting zone is located approximately 220 mm rearwardly from the center of the sprocket wheel.

14) A stand-up snow vehicle as claimed in claim 13, wherein the center of the first ground contact zone is located at about 600 mm in front of the center of the sprocket wheel.

15) A stand-up snow vehicle as claimed in claim 1, wherein the first angle is selected to increase the distance between the first ground contact zone and the second ground contact zone.

16) A stand-up snow vehicle as claimed in claim 1, wherein the platform extends approximately 1100 mm rearwardly of the center of the sprocket wheel.

17) A stand-up snow vehicle as claimed in claim 16, wherein the platform is made of anti-slip material with channels allowing the removal of ice and snow.

18) A stand-up snow vehicle as claimed in claim 1, wherein the width of the platform is between 300 and 355 mm.

19) A stand-up snow vehicle as claimed in claim 1, wherein the steering assembly, the engine system and the bracket element are in a separate module from the endless track system.

20) A stand-up snow vehicle comprising:
a steering assembly positioned at an angle of 63 degrees plus or minus 1 degree from the horizontal to optimize the absorption of bumps while minimizing the force transfer impact of deceleration and acceleration, the steering assembly comprising a ski having a first ground contact zone, the ski being rotatable by a user to change a direction and course of the vehicle;
at least one endless track system comprising a sprocket wheel driving a flexible track having a second ground contact zone;
an engine system;
a platform positioned at an angle of 6 degrees plus or minus 1 degree from the horizontal;
wherein the center of gravity is positioned close to the ground.
